(19) United States
(12) Patent Application Publication
(10) Pub. No.: US 2003/0101853 A1
(43) Pub. Date: Jun. 5, 2003

(54) Hand tool having a protective layer and its manufacturing method

(76) Inventor: Hsiao-feng Mai, Taichung City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 09/902,720

(22) Filed: Jul. 12, 2001

(51) Int. Cl. B25G 1/01

(52) U.S. Cl. 81/489

(57) ABSTRACT

A hand tool having a protective layer and its manufacturing method are disclosed. It comprises a covered portion and a non-covered portion. An outer surface of the covered portion is disposed with at least one protective layer by plastic injection. An outer surface of the non-covered portion is coated with a thin electroplating layer. Regarding the manufacturing method, the plastic injection technique is utilized to form a protective layer at any desired portion. After which, by the electroplating step, an electroplating layer is formed on the non-covered portion. So, the application scope of this invention's protective layer is wide, it will not waste material, and only enhances the holding feeling but also improves the anti-slip effect.

### BACKGROUND OF THE INVENTION

1. Field of the Invention

This invention relates to a hand tool and its manufacturing method, especially to a hand tool having a plastic injection protective layer and its manufacturing method. In which, it contains the advantages and functions including that the application scope of this invention's protective layer is wide, it will not waste material, and it not only enhances the holding feeling but also improves the anti-slip effect.

2. Description of the Prior Art

Referring to FIGS. 1 to 3, the manufacturing method of a traditional hand tool having a protective layer comprises:

(1) basic process step 91: one or more parts of the hand tool 80 is formed or assembled into an electrically conductive hand tool 80.

(2) electroplating step 92: to let the hand tool 80 immerse in an electroplating liquid to form an electroplating layer 81 thereon.

(3) fitting around step 93: Fit a sleeve-like conventional protective layer 82 around the hand tool 80. Please note the cross-sectional area of the conventional protective layer 82 is ring-shaped. After the electro-plating step is done, the outer surface of hand tool 80 becomes very shiny and slippery. Although the conventional protective layer 82 with the ring-shape cross-sectional area cannot firmly adhere on the hand tool 80, the sleeve structure enables the conventional protective layer 82 to firmly secure on the hand tool 80 by the fitting method.

(4) final product step 94: to complete the final product of the hand tool 80.

However, because the conventional protective layer 82 cannot firmly adhere on the outer surface of the hand tool 80 (because of the slippery interface therebetween), the only way is to secure it is to utilize the fitting method. If the hand tool 80 has a regular structure (such as a circular rod or a hexagonal rod of a screwdriver or a hammer), this fitting method is possible to allow the protective layer 82 to fit around.

But, for those hand tools having irregular structures or special structures, the traditional fitting method will not work. For example, for a special protective layer 83 shown in the phantom line in FIG. 4 or another separated multiple protective layers 84 shown in the phantom line in FIG. 5 (not ring-shaped), it is impossible to secure such protective layer (83 or 84) on the hand tool 80 by the traditional fitting method. In addition, if the handle is C-shaped (like the one shown in FIG. 9), it is also impossible to use the traditional fitting method to secure a conventional protective layer 82 only on the outer side of the C-shaped structure. At this time, anti-slip knurled sections or spaced protrusions on the metal hand tool is technically possible and helpful. However, the hard and solid knurled sections or protrusions will bring the disadvantage of uncomfortable feeling.

Therefore, its is necessary to invent a new product and new method to solve the above-mentioned problems.

### SUMMARY OF THE INVENTION

The primary object of this invention is to provide a hand tool having a protective layer. In which, the plastic injection protective layer is formed before the electro-plating procedure. This invention is suitable for the hand tool having an irregular structure or special structure. So, the application scope of this invention's protective layer is wide.

The second object of this invention is to provide a hand tool having a protective layer. Its protective layer can be disposed on the portion where hand contacts only, especially on the outer side of the handle portion of a hand tool. Thus, it will not waste material.

The other object of this invention is to provide a hand tool having a protective layer. It not only enhances the holding feeling but also improves the anti-slip effect so that when the user operate this hand tool, this user will feel more comfortable and can manipulate it more precisely.

This invention is to provide a hand tool having a protective layer comprising: a covered portion and a non-covered portion; an outer surface of said covered portion being disposed with at least one protective layer made by plastic injection, each of said protective layer having a first edge and a second edge, and said first edge and said second edge being spaced; an outer surface of said non-covered portion being coated with an electro-plating layer.

Also, this invention is to provide the manufacturing method of hand tool having a protective layer mainly comprising the following steps: (a) basic process step, (b) pre-injection processing step, (c) inserting into an mold set step, (d) injection forming step, (e) taking out from mold set step, (f) electroplating step, and (g) final product step: to complete the final product of said hand tool.

### BRIEF DESCRIPTION OF THE DRAWINGS

FIG. 1 is a flow chart showing the manufacturing method of a traditional hand tool having a protective layer by fitting method.

FIG. 2 shows a traditional hand tool before the electro-plating process is done.

FIG. 3 is perspective view of the traditional hand tool after fitting on a protective layer.

FIG. 4 illustrates a special type of the protective layer that the traditional method cannot make it.

FIG. 5 illustrates another special type of the protective layer that the traditional layer cannot make it.

FIG. 6 is a flow chart of the manufacturing method of this invention

FIG. 7 is a perspective view of tnis invention before proceeding the plastic injection step.

FIG. 8 is a perspective view of this invention when the hand tool is inserted inside the molds for plastic injection.

FIG. 9 is a cross-sectionai view in FIG. 8 showing the predetermined space.

FIG. 10 shows a selected portion of final product of this invention.

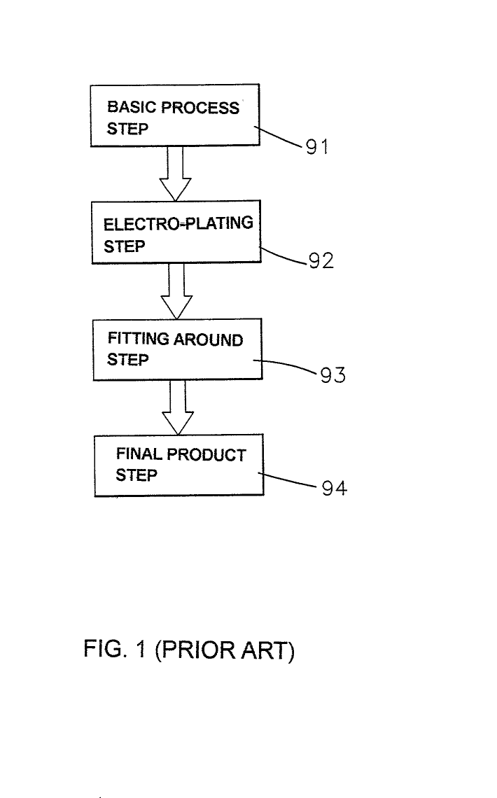

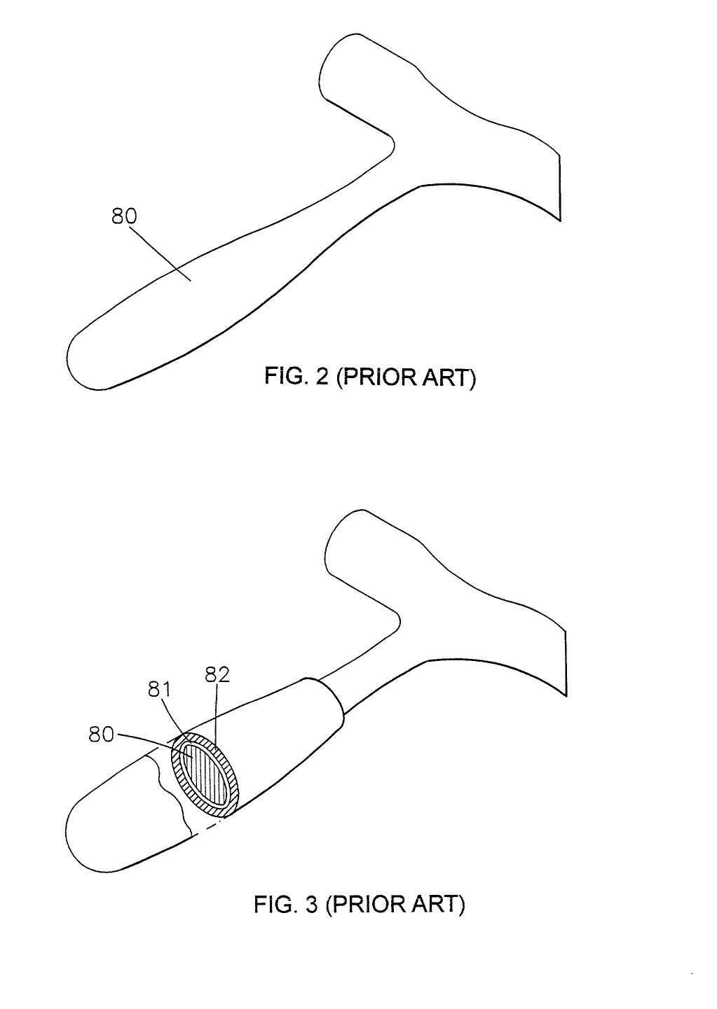

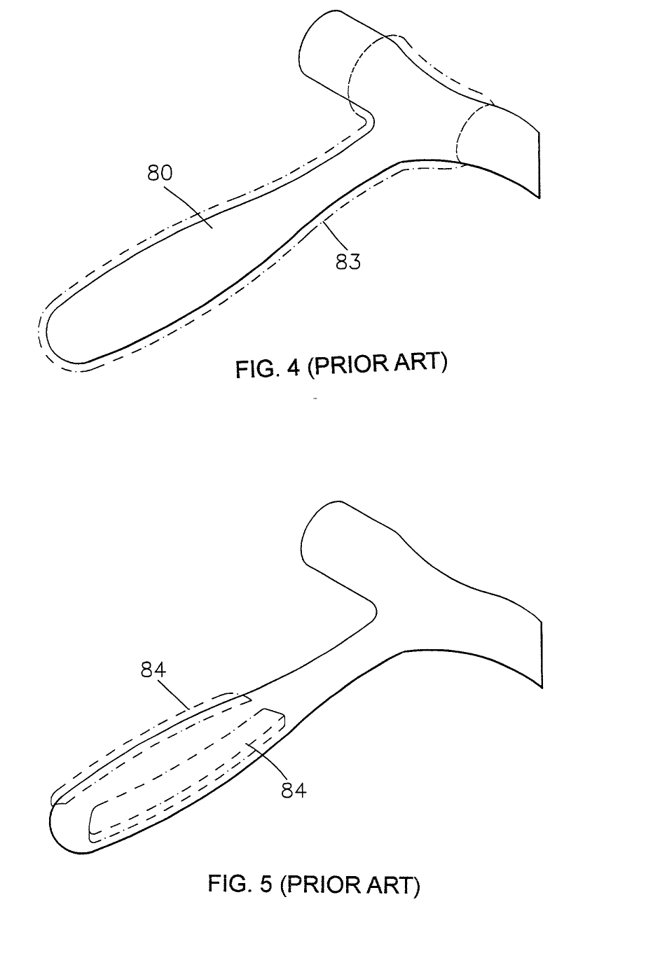

### DETAILED DESCRIPTION OF THE PREFERRED EMBODIMENT

This invention is a hand tool having a handle protective layer and its manufacturing method. It contains two parts: the product and its manufacturing method.

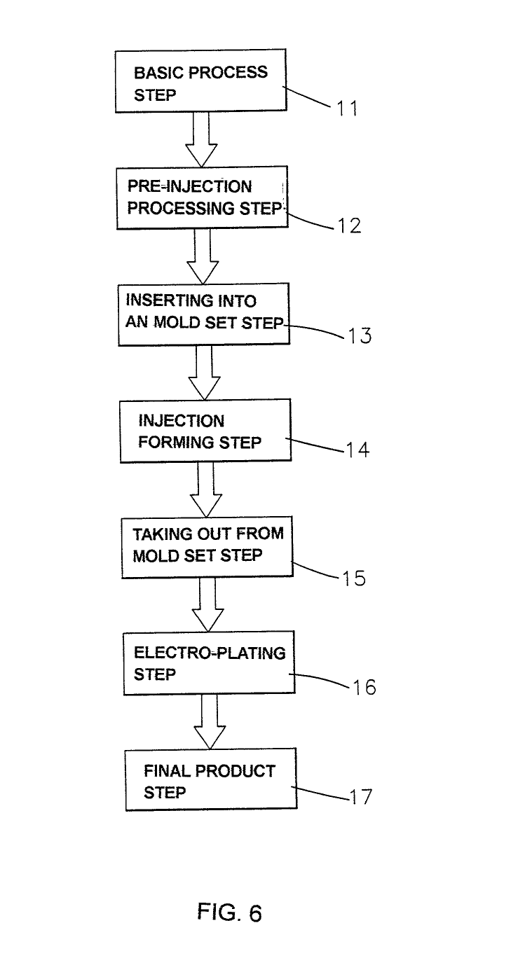

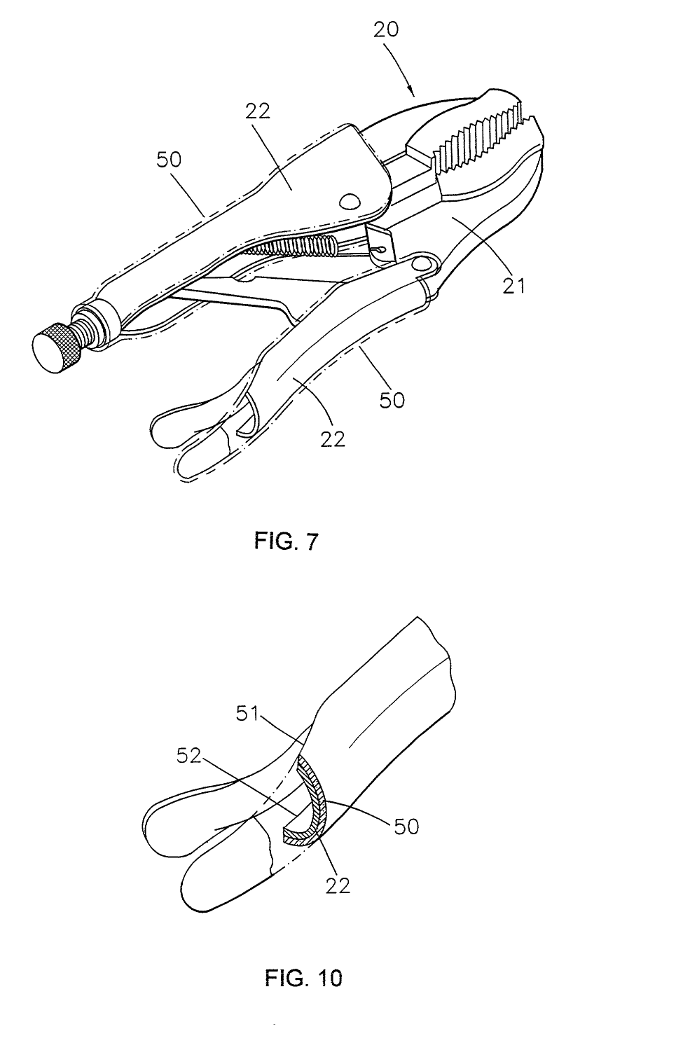

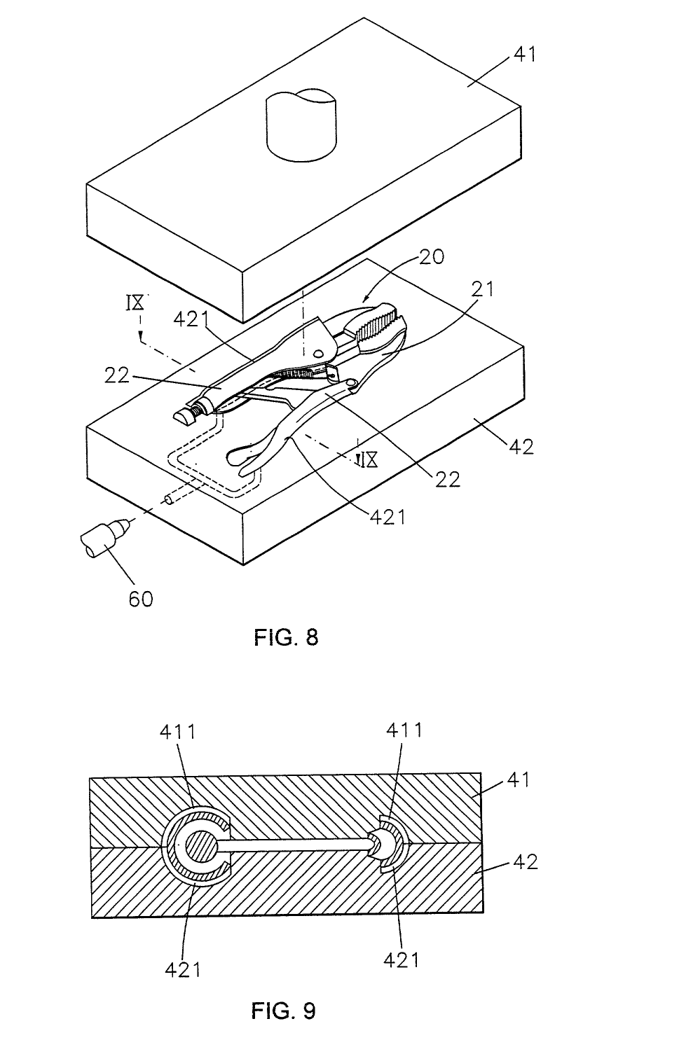

First, the flow chart of the manufacturing method is shown in FIG. 6. The related structure of this invention can be seen in FIGS. 7 to 10. The manufacturing method of the hand tool having a protective layer comprises the following steps:

(a) basic process step 11: one or more parts of the hand tool 20 is formed or assembled into an electrically conductive hand tool 20. This hand tool 20 includes a covered portion 22 (usually the handle or any desired portion) and a non-covered portion 21 (such as the front portion to clamp or contact the working object).

(b) pre-injection processing step 12: to clean an outer surface of the covered portion 22 (where the protective layer 50 to be located) of the hand tool 20 and remove oil on the outer surface. Then, it is to coat or paint an adhesive layer thereon. In practical use, this thin adhesive layer can be any available instant glue with high adhesive property.

(c) inserting into an mold set step 13: to insert the hand tool 20 into a mold set having two molds 41, 42; after the molds 41,42 is closed, a pre-determiined space 411, 421 is formed for an injection material to fill in.

(d) injection forming step 14: by utilizing a plastic injection machine 60 to inject a plastic material into the pre-determined space 411, 421 so as to form a protective layer 50. Then, it is to cool down and let the protective layer 50 be solidified.

(e) taking out from mold set step 15: to open the molds 41, 42 and the protective layer 50 is formed and firmly secured on the hand tool 20.

(f) electro-plating step 16: let the hand tool 20 immerse in an electro-plating liquid to form an electro-plating layer (a very thin layer thereon, not labeled) on the non-covered portion 21 of the hand tool 20.

(g) final product step 17: to complete the final product of the hand tool 20.

Moreover, for a more complex hand tool such as pliers, the basic process step 11 further comprises:

(1) part forming sub-step: several parts are formed (no matter by cutting, machining, casting. etc.);

(2) heat treating sub-step: to proceed a heat treating for these parts; and

(3) assembling sub-step: to assemble these parts into a hand tool.

However, if the hand tool only contain one single part (like a screwdriver or a hammer), please note that there will be no such assembling sub-step.

With regard to the final product, this invention “hand tool having a protective layer” mainly comprises a covered portion 22 and a non-covered portion 21.

In which, an outer surface of the covered portion 22 is disposed with at least one protective layer 50 by plastic injection. Each of the protective layer(s) 50 has a first edge 51 and a second edge 52. And, the first edge 51 and the second edge 52 are spaced. They do not contact each other. That is, the protective layer 50 does not form a ring-shaped encircle structure.

An outer surface of the non-covered portion 21 is coated with an electroplating layer for keep the product shiny and avoid rusting.

That is, the cross-sectional area of the protective layer 50 is a C-shaped or irregular shaped. It will not form a sleeve-typed structure to encircle an inner object (which can be secure by fitting method).

Therefore, this invention is suitable for the hand tool having an irregular structure or special structure. So, the application scope of this invention's protective layer is wide.

In addition, the protective layer can be disposed on the portion where the user's hand contacts only, especially the outer side of the handle portion of a hand tool. There is no need to cover the non-contacted portion (especially the inner side thereof). Thus, it will not waste material.

Besides, the protective layer of the hand tool with irregular structure or special structure not only enhances the holding feeling but also improves the anti-slip effect so that when the user can operate this hand tool, this user will feel more comfortable and can manipulate it more precisely.

The above embodiments are only used to illustrate the present invention, not intended to limit the scope thereof. Many modifications of the above embodiments can be made without departing from the spirit of the present invention.

What is claimed is:

1. A hand tool having a handle protective layer comprising:
a covered portion and a non-covered portion;
an outer surface of said covered portion being disposed with at least one protective layer made by plastic injection, each of said protective layer having a first edge and a second edge, and said first edge and said second edge being spaced;
an outer surface of said non-covered portion being coated with an electro-plating layer.

2. A manufacturing method of hand tool having a protective layer comprising the following steps:
(a) basic process step: one or more parts of said hand tool being formed or assembled into an electrically conductive hand tool, said hand tool including a covered portion and a non-covered portion;
(b)pre-injection processing step: to clean an outer surface of said covered portion of said hand tool and remove oil on the outer surface, then to coat or to paint an adhesive layer thereon;
(c) inserting into an mold set step: to insert said hand tool into a mold set having two molds; after the molds closed, a pre-determined space is formed for an injection material to fill in;
(d)injection forming step: by utilizing a plastic injection machine to inject a plastic material into said pre-determined space so as to form a protective layer; then to cool down and let said protective layer be solidified;
(e) taking out from mold set step: to open said molds and said protective layer is formed on said hand tool;
(f) electro-plating step: let said hand tool immerse in an electro-plating liquid to form an electro-plating layer on said non-covered portion of said hand tool; and
(g) final product step: to complete the final product of said hand tool.

3. The manufacturing method of hand tool having a protective layer, wherein said adhesive layer is an instant glue with high adhesive property.
